(19) United States
(12) Patent Application Publication
(10) Pub. No.: US 2005/0277462 A1
(43) Pub. Date: Dec. 15, 2005

(54) Method and system for managing casino credit

(76) Inventor: Gary Ellis, Las Vegas, NV (US)

Correspondence Address: MORISHITA LAW FIRM, LLC, 3800 HOWARD HUGHES PARKWAY, SUITE 850, LAS VEGAS, NV, 89109, US

(21) Appl. No.: 10/825,262

(22) Filed: Apr. 14, 2004

Related U.S. Application Data
(63) Continuation-in-part of application No. 09/730,664, filed on Dec. 6, 2000, now abandoned.

(51) Int. Cl. G06F 19/00; G06F 17/00

(52) U.S. Cl. 463/25

(57) ABSTRACT

A method for managing casino credit includes identifying a player at a gaming machine and extending credit to the player. So long as the total credit extended is less than the player's winnings, the gaming machine is disabled from cashing out the player's winnings. Optionally, when the winnings exceed the total credit extended, the gaming machine is enabled to cash out the player's net winnings. A system for managing casino credit includes gaming machines communicating with a server. The gaming machines may be located at more than a single casino property.

### RELATED APPLICATION DATA

The present application is a continuation-in-part of U.S. application Ser. No. 09/730,664 entitled “A Gambling Credit Card and Method Therefor” filed Dec. 6, 2000 by Applicant herein.

### FIELD OF THE INVENTION

The present invention relates to casino credit management. More specifically, the present invention is a method and system for managing credit extended by casinos to a player that controls the conditions under which the player is permitted to cash out.

### BACKGROUND OF THE INVENTION

Casino credit is a method for gamblers to gamble without the need for cash. Casino credit takes many forms. For example, one form of casino credit is called “check cashing” in which the casino extends credit to a player in exchange for a bank draft or check that is held by the casino for a period of time, however briefly, before the casino deposits the check. Another form of casino credit takes place when the casino grants an unsecured loan, sometimes called a marker, to a player. In any case, the player typically utilizes the credit by receiving gaming chips up to the amount of credit authorized.

These and other conventional forms of casino credit are risky, however. One risk of casino credit is collection. That is, if the player loses the credit advanced, the casino must determine whether and how the credit will be repaid. In the case of an unsecured marker, the casino bears the risk of arranging repayment by the player and ensuring the player actually repays the credit. In the case of check cashing, the held check can be deposited, but the casino still runs the risk that the check will be dishonored by the payor bank.

A related problem arises when unscrupulous players obtain casino credit, then cash out, taking the monetary value of the casino credit from the casino. For example, such a player may obtain $5,000 in credit, utilize the credit by obtaining $5,000 in gaming chips, play for a short period, then cash out by exchanging the gaming chips for currency. Such a player could leave the casino with approximately $5,000 in currency that does not rightly belong to the player and that the player has no intention of using to repay the casino.

The response by the casinos has been to tighten its credit by more carefully scrutinize those applying for credit. This response, however, is far from foolproof because the method of extending credit has not changed. Thus, casinos can still be cheated by a dishonest player who possesses, or manufactures, a good credit history. Moreover, by tightening credit, the casino is potentially reducing the number of players gambling as well as the amount the remaining players may gamble.

Therefore, it can be seen that there is a need in the art for a new method and system for managing casino credit.

### SUMMARY OF THE INVENTION

The present invention is a method and system for managing and controlling credit used by a player gambling at one or more gaming machines. A method includes determining a credit limit for the player. Optionally, a number of factors are used to approve the player for credit and determine a credit limit. Also, in an optional embodiment, especially where more than one gaming machine is provided, the credit limit may be stored in a manner accessible to the gaming machines. Using the credit limit, and the credit previously extended to the player, if any, the credit available is calculated as the difference between the credit limit and the credit previously extended. In an optional embodiment discussed in greater detail below, net winnings previously stored may be added to the credit available.

The player is identified at a gaming machine. The identification may optionally be performed in a variety of ways including, but not limited to, a magnetic card, a smart card, a bar code, a personal identification number, biometric identification, a transponder, or any other method of identification. Upon the player being identified at the gaming machine, credit, in an amount less than or equal to the credit available, is extended to the player.

As the player plays at the gaming machine, the player's winnings are tracked. Likewise, the total credit extended to the player is calculated and tracked. The total credit extended to the player is the sum of the credit extended at the gaming machine and the credit previously extended, if any. In an optional embodiment, winnings may be applied against the total credit extended. Also, in an optional embodiment, the total credit extended may be stored in a manner accessible to the gaming machine.

So long as the winnings are less than the total credit extended, the gaming machine is disabled from cashing out the winnings by issuing media of exchange. In other words, gaming machine is disabled from issuing cash, coin, vouchers, gaming chips or checks, or any other fungible value media so long as the winnings are less than the total credit extended.

In an optional embodiment, however, when the winnings are greater than the total credit extended, the gaming machine is enabled to cash out all or a portion of the net winnings where the net winnings are calculated as the amount by which the winnings exceed the total credit extended. That is, in such an optional embodiment, gaming machines are enabled to issue cash, coin, vouchers, gaming chips or checks, or any other fungible value media, but only for an amount less than or equal to the net winnings.

Alternatively or additionally, the player may be provided the option to store all or a portion of net winnings in a manner accessible to the one or more gaming machines rather than cashing out. In such an optional embodiment; any net winnings previously stored may be added to the credit available.

In an optional embodiment, the method is carried out by gaming machines communicating with a server. The gaming machines may be located at a single casino property or across two or more casino properties. In an optional embodiment in which the gaming machines are located at two or more casino properties, the credit extended by the gaming machines may be grouped according to the casino property where the gaming machines are located. The groupings may be ordered so that any winnings may be applied according to the ordering. Optionally, the ordering is chronological.

A system for managing and controlling credit used by a player for gambling includes a server communicating with a plurality of gaming machines. The gaming machines may be located at a single casino property or across two or more casino properties. The server includes a server data structure that stores instructions, such as software, executable by a server data processor. The instructions implement a method in which the server determines a credit limit and stores the credit limit at the server data structure. The server also calculates the credit available to a player by calculating the difference between the credit limit and the credit previously extended to the player, if any.

The gaming machines each include a machine data processor executing instructions stored at a machine data structure. The instructions implement a method in which credit is extended to the player in an amount less than or equal to the credit available upon the player being identified at the gaming machine. The total credit extended to the player is calculated by summing the credit extended at the gaming machine and the credit previously extended, if any. The player's winnings are tracked at the gaming machine. Optionally, the winnings are applied against the total credit extended. The gaming machine is disabled from cashing out the winnings, that is, issuing media of exchange, so long as the winnings are less than the total credit extended.

In an optional embodiment, when the winnings are greater than the total credit extended, the gaming machine is enabled to cash out at least a portion of the net winnings, that is, the amount by which the winnings exceed the total credit extended. In a further optional embodiment, the player is provided the optional to store at least a portion of the net winnings in a manner accessible to the gaming machines rather than cashing out. In such an optional embodiment, the net winnings may optionally be accessed by the player along with the credit available.

In an embodiment in which the gaming machines are located across multiple casino properties, the system may further include instructions for grouping the credit extended by the plurality of gaming machines according to the casino property where each gaming machine is located. The groupings would then be ordered and any winnings would be applied against the groupings according to the ordering. Optionally, the ordering is chronological.

### BRIEF DESCRIPTION OF THE DRAWINGS

FIG. 1 is a flowchart of a method according to an embodiment of the present invention;

FIG. 2 is a flow chart of a method according to an alternate embodiment of the present invention;

FIG. 3 is a flow chart of a method according to an alternate embodiment of the present invention;

FIG. 4 is a flow chart of a method according to an alternate embodiment of the present invention;

FIG. 5 is a block diagram of a system according to an embodiment of the present invention;

FIG. 6 is a block diagram of a server and gaming machine according to an embodiment of the present invention.

### DESCRIPTION

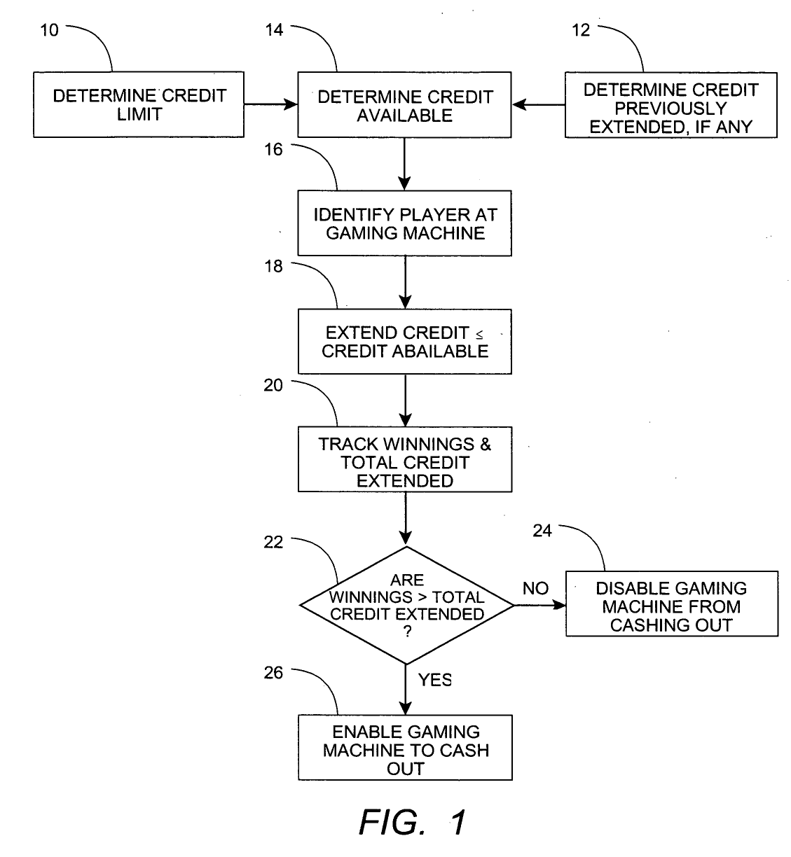

Reference is now made to the figures wherein like parts are referred to by like numerals throughout. Referring generally to FIGS. 1-6, the present invention is a method and system for managing casino credit. The method of the present invention could be implemented in many different ways, including through software, hardware, firmware, remote processing, or the like, or a combination thereof. The method is directed to use at a gaming machine 42, but the term “gaming machine” includes all machines for the conduct of gaming and should not be limited to slot machines and video poker machines. In fact, “gaming machine” may include any device used in gaming that dispenses a medium of exchange, such as coins, cash, vouchers, tickets, gaming chips, or other fungible value media, or electronic representations thereof. This specifically includes chip and ticket handling machines that convert gaming chips, tickets, game credits, or electronic representations thereof, into currency. Moreover, the present invention specifically contemplates use of the present method and system with gaming tables.

Also, it is contemplated that the present method could be implemented at one or more gaming machines 42. That is, the method could be implemented at a single gaming machine 42, a plurality of gaming machines 42 operating separately, a plurality of networked gaming machines 42, a plurality of gaming machines 42 networked with a server 44, or any combination or variation thereof. In one optional embodiment of the system described in greater detail below, the gaming machine 42 communicates with a server 44.

The method may optionally include collecting information from a player and using that information to approve the player for credit and open a credit account. It is noted that the process of applying for credit may be remote from the casino location in both time and location. That is, it is contemplated that an optional embodiment could allow a player could apply for credit in advance from a remote location, such as the player's home, through the mail, telephone, Internet, or the like. Similarly, the player could optionally receive approval and an identification device, in an embodiment utilizing an identification device, through the mail, telephone, Internet, or the like.

Factors influencing whether a player is approved for credit could optionally be conventional factors such as the player's credit and financial history. However, it should be noted that no factors are mandatory in the present method and any factors, or no factors at all, could be considered in approving a credit account. Additional information, such as name, address, social security number, and/or credit card number, may be acquired for identification and collections purposes.

Referring generally to FIGS. 1-4, a credit limit is determined 10. Although the credit limit could be fixed, it is also contemplated that the credit limit may vary from player to player. Again, any number of factors, or no factors at all, could be used to determine 10 a credit limit. Factors, if considered, could include credit and financial history. Optionally, the credit limit is stored. Optionally, the stored credit limit is accessible to the gaming machine 42 and/or server 44 as described in greater detail below.

Credit previously extended to the player is determined 12 and the credit available to a player is calculated 14 by taking the difference between the credit limit and the credit previously extended, if any, to the player. The credit previously extended, if any, to a player could be determined 12 from input from a casino operator, a value previously stored, or the like. Thus, for a new account, the full credit limit may be available to the player. For an existing account, less than the full credit limit may be available to the player, if the player has already received credit. For example, suppose a player has a credit limit of $1,000.00. If no credit was previously extended to the player, the player would have $1,000.00 credit available. Conversely, if $250.00 in credit was previously extended to the player, the player would have $750.00 credit available. In an optional embodiment, the credit available may also include any net winnings previously stored, as discussed in greater detail below.

The player is identified 16 at a gaming machine 42. The player may be identified 16 in a variety of ways including encoded identification card, smart card, bar code, magnetic code, signal transmitter, transponder, token, personal identification number (“PIN”), biometric measurement, visual identification, audio or voice identification, facial recognition, or any other form of identification. Upon the player being identified 16, the gaming machine 42 extends 18 credit to the player in an amount less than or equal to the credit available. The amount could be selected by the player, determined by the machine, extended on an as-needed basis, or extended 18 in any other fashion, so long as the credit limit is not exceeded.

As the player plays uses the gaming machine 42, the player's winnings and total credit extended are tracked 20. Since the gaming machine 42 must track wins and losses, in an optional embodiment, the tracking 20 of the winnings and total credit extended is in real time. However, it is contemplated that the tracking 20 need not be in real time and could optionally be on a periodic basis or a per session basis.

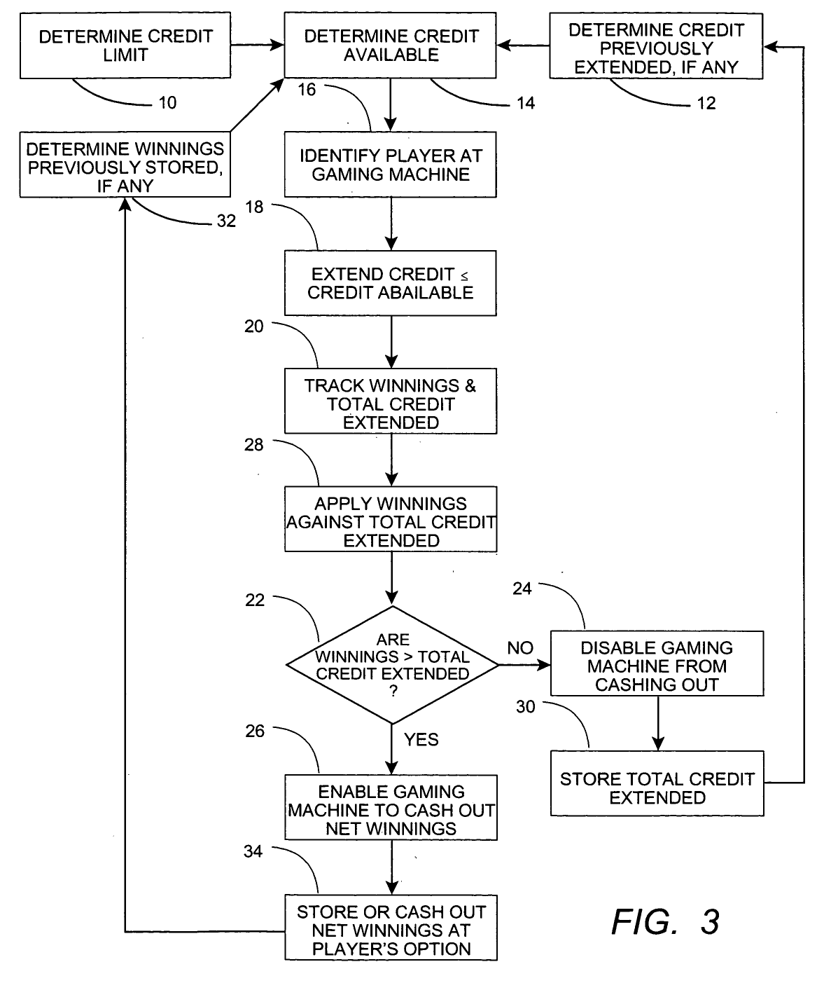

The total credit extended to a player would be the sum of the credit previously extended, if any, and the credit extended at the gaming machine 42. For example, if a player was previously extended $100.00 in credit and receives another $200.00 in credit at a gaming machine 42, the total credit extended is $300.00. The total credit extended may be running total, or may be updated periodically. Optionally, as shown in FIG. 3, the total credit extended may be stored 30 in a location accessible to the gaming machine 42. It is this value that may be included 12 as “credit previously extended” when determining 14 credit available to a player.

Returning to FIGS. 1-4, so long as the winnings are less than the total credit extended 22, the gaming machine 42 is disabled 24 from cashing out the player. “Cashing out” occurs when a player exchanges the winnings in a gaming machine 42 for media of exchange, such as cash, coin, voucher, ticket, or other fungible value media representing currency. Thus, if the total credit extended is $200.00 and the player's winnings are $175.00, the gaming machine 42 is disabled 24 from cashing out the player's winnings.

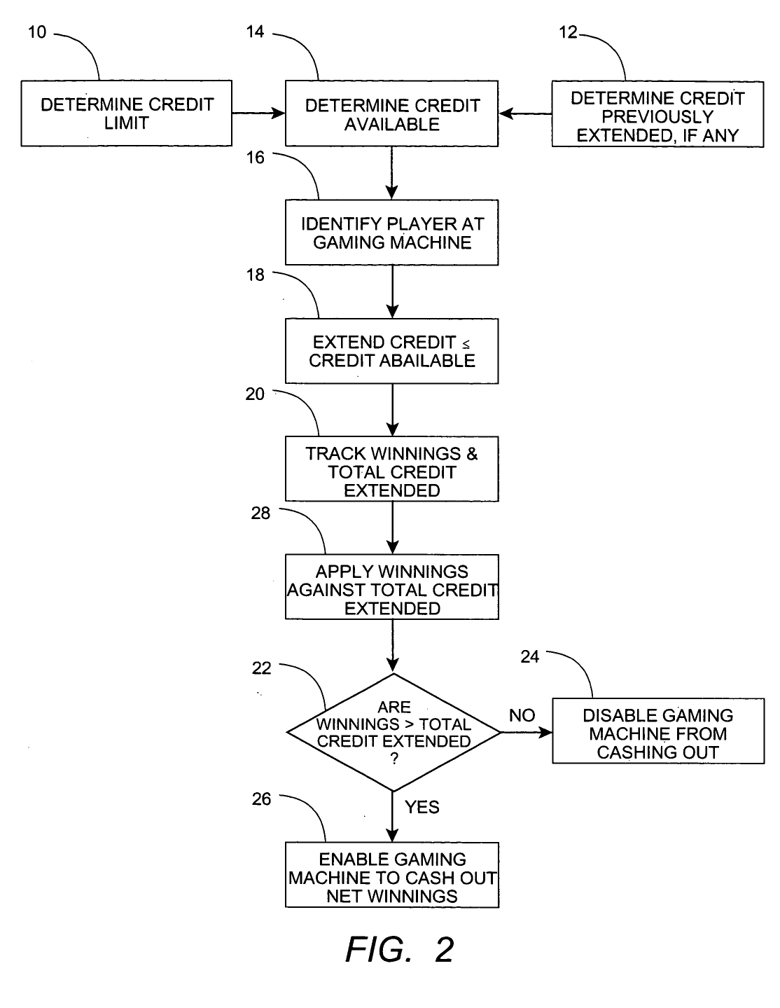

However, in an optional embodiment shown in FIGS. 2-4, winnings are applied 28 against the total credit extended. In such an embodiment, the winnings are applied 28 against the total credit extended to reduce the total credit extended or, in effect, make a payment against the total credit extended. Thus, in an example where the total credit extended is $200.00 and the player's winnings are $175.00, the winnings may be applied against the total credit extended to reduce the total credit extended to $25.00.

In a further optional embodiment, shown in FIGS. 1-4, the gaming machine 42 is enabled 26 to cash out a player when, and to the extent that, the player's winnings exceed the total credit extended. In other words, in such an optional embodiment, the amount by which the winnings exceed the total credit extended is designated the net winnings. The gaming machine 42 in such an optional embodiment is enabled 26 to cash out the net winnings. For example, in such an optional embodiment, if the total credit extended is $400.00 and the player's winnings are $450.00, the gaming machine 42 is enabled 26 to cash out $50.00 in net winnings. Optionally, the remainder is applicable against the total credit extended. Thus, in the preceding example, $400.00 of the winnings could be applied 28 against the total credit extended and the gaming machine would be enabled 26 to cash out $50.00 of the winnings.

In another optional embodiment, shown in FIG. 3, the player may be presented the option 34 of storing at least a portion of the net winnings in a manner accessible to the gaming machine 42 rather than cashing out. For example, in such an optional embodiment, if a player has net winnings of $50.00, the player may store or cash out any combination of the $50.00, for example by cashing out $20.00 and storing $30.00, at his or her option 34. In a variation on such an optional embodiment, the entire net winnings may be stored to be cashed out at a central location such as a cashier or casino cage.

In either case, the previously stored net winnings would be included 32 in the calculation of the credit available at a gaming machine 42. For example, if a player has $50.00 in net winnings stored and a credit limit of $500.00, the player will be able to access $550.00 at the gaming machine 42. For simplicity, the entire $550.00 is referred to as the player's credit available, even though $50.00 of the sum is not truly credit but stored net winnings.

It is also noted that in most situations, a player will not have both net winnings stored and credit previously extended stored. That is, under most circumstances, net winnings stored and credit previously extended stored are mutually exclusive since winnings, in an optional embodiment, are applied 28 against total credit extended. Thus, if the winnings are less than 22 the total credit extended, the method could store 30 the difference as credit previously extended and if the winnings exceed 22 the total credit extended, the method could store 34 the difference as net winnings.

At several points in the method, data may optionally be stored 30, 34 in a manner accessible to the gaming machine 42. Examples of data that might be stored include credit limit, total credit extended, winnings and/or net winnings, and the like. Storage and retrieval could occur in many different ways. In one optional embodiment, the data may be stored in a portable device, such as the same device used by the player to identify himself or herself at the gaming machine 42. For example, in such an optional embodiment, if the player uses a smart card, magnetic stripe card, transponder, transmitter, or the like to identify 16 the player at the gaming machine 42, the same device could store 30, 34 data accessible to the gaming machine 42.

In an alternate embodiment, such as one in which a plurality of gaming machines 42 communicate with one another or with a server 44, data may be stored at a gaming machine 42 or a server 44. When the method calls for storing data, the data could be communicated to the storage location. Similarly, when the method calls for retrieving stored data, the data could be communicated from the storage location.

As noted previously, the present method may be applied to a plurality of gaming machines 42. It is contemplated that in such an embodiment the gaming machines 42 may be located at one or more casino properties. In other words, the gaming machines 42 may be located at one casino property, or across two or more casino properties. In the optional embodiment in which gaming machines 42 are located across two or more casino properties, the method may be implemented substantially as described.

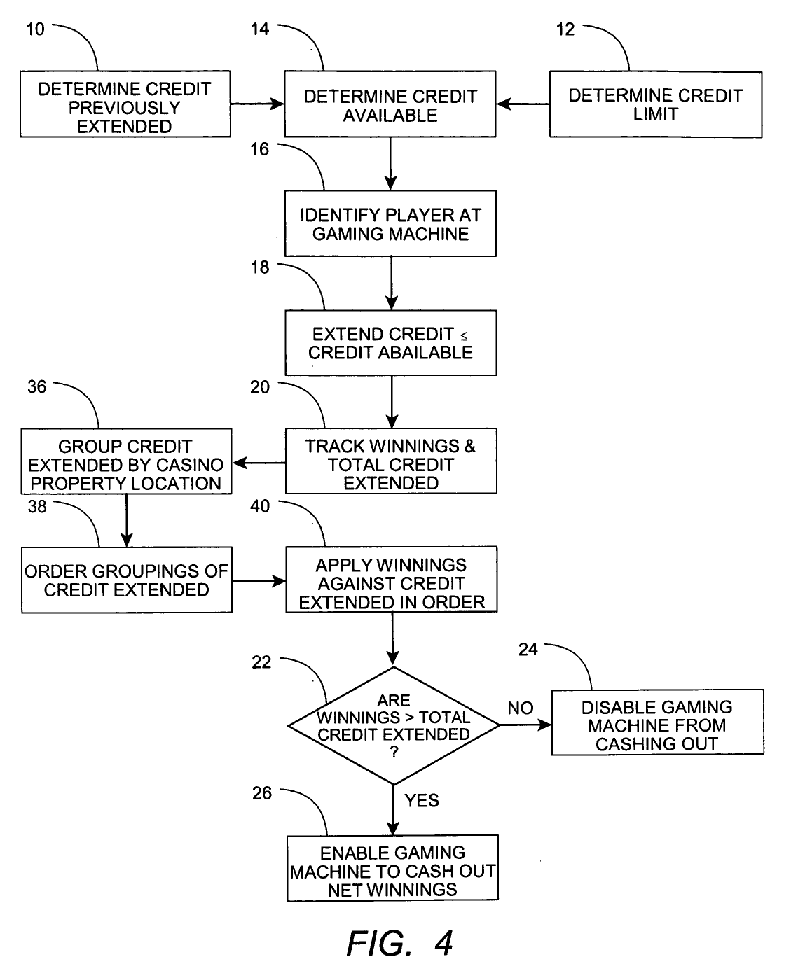

In a further embodiment shown in FIG. 4, however, the method may optionally include grouping 36 the credit extended at the gaming machine 42 or gaming machines 42 according to the casino property where each gaming machine 42 is located. For example, if a player is extended $50.00, $75.00, and $25.00 in credit at various gaming machines 42 at Casino A and $100.00 and $20.00 in credit at various gaming machines 42 at Casino B, the method includes grouping 36 the credit extended according to location, i.e. $150.00 at Casino A and $120.00 at Casino B.

The groupings of credit are then ordered 38 and winnings are applied 40 according to the ordering. While the groupings could be placed in any order, in an optional embodiment, the ordering 38 is chronological. Thus, in the example above, suppose the player played at Casino A before playing at Casino B. The credit extended at Casino A would be ordered 38 before the credit extended at Casino B and winnings, regardless of where they occurred, would be applied 40 to the credit extended at Casino A before being applied to the credit extended at Casino B. It is contemplated that the reconciliation of winnings and credit extended when multiple properties are involved could take place in continuously or periodically.

Continuing with the previous example where a player was extended $150.00 credit at Casino A before being extended $120.00 credit at Casino B, would have $90.00 in winnings applied to the credit extended at Casino A for a final account of $60.00 credit extended at Casino A and $120.00 credit extended at Casino B. If the same player then has $70.00 in additional winnings, $60.00 of the winnings would be applied against the $60.00 credit extended at Casino A and $10.00 of the winnings would be applied against the $120.00 credit extended at Casino B. It should be noted that since the player still has $110.00 total credit extended, a gaming machine at either Casino A or Casino B would be disabled from cashing out the player even though his current account is $0.00 credit extended at Casino A and $110.00 extended at Casino B.

Many different systems could implement the method of the present invention. Moreover, the steps of the present method could occur at different parts of a system, at a single part of a system, in parallel across the system, or in any other fashion.

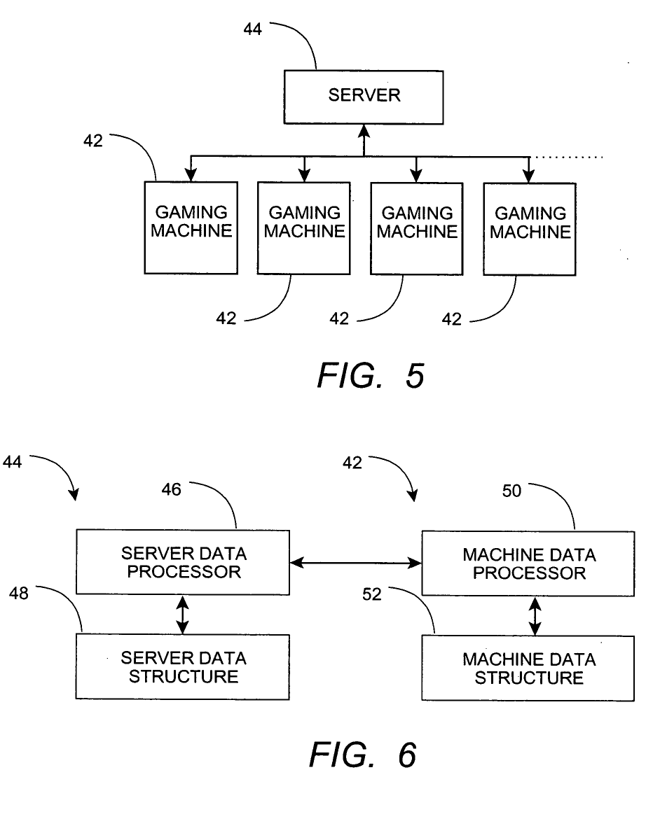

One optional embodiment of a system implementing the method of the present invention is shown in FIGS. 5 and 6 and could include a server 44, having a server data processor 46 and a server data structure 48, communicating with a plurality of gaming machines 42, each having a machine data processor 50 and a machine data structure. It is contemplated that the server data structure 48 and machine data structure 52 could be any form of data structure including, for example, magnetic storage, optical storage, electrical storage, random access memory, flash memory, read-only memory, or any other form of data storage or memory device.

With reference generally to the method of FIGS. 1-4, and the system of FIGS. 5 and 6, the server data processor 46 executes instructions for determining 10 a credit limit for a player and storing the credit limit at the server data structure 48. The credit limit could be determined 10 simply by receiving input from an operator or could be calculated based on one or more factors. Examples of the factors that could be considered were given above.

The server data processor 46 also determines 12 the credit previously extended to the player. Again, this could be done in many different ways. Two possible examples would be receiving input from an operator or retrieving a value representing the credit previously extended that is stored 30 in the server data structure 48 or elsewhere. The credit available is calculated by subtracting the credit previously extended from the credit limit. In an optional embodiment in which all or a portion of net winnings are stored 34, the net winnings may be included in the credit available.

Before describing the role of the machine data processor 50, it is noted that the machine data processor 50 may be unitary with, or separate from, the data processor in the gaming machine 42 that conducts play of the game. That is, a single data processor may conduct the game and execute a method according to the present invention. It is also possible, however, that separate and independent data processors may be used for the execution of the present method, on the one hand, and the conduct of the game, on the other hand, even though certain data would likely need to be accessed by both data processors.

The machine data processor 50 executes instructions for identifying 16 the player at the gaming machine 42. Examples of methods and devices for identifying 16 the player were given above. Credit is extended 18 to the player in an amount less than or equal to the credit available. The gaming machine 42 tracks 20 the player's winnings and calculates the total credit extended as the sum of the credit extended at the gaming machine 42 and the credit previously extended, if any. Optionally, as discussed above, the winnings may be applied 28 against the total credit extended.

So long as the winnings are less than the total credit extended, the machine data processor 50 disables 24 the gaming machine 42 from cashing out the player. That is, the gaming machine 42 is disabled 24 from cashing out the player until the condition 22 that the winnings be greater than the total credit extended is satisfied. In a further optional embodiment, the gaming may be enabled 26 to cash out the player when the winnings are greater than the total credit extended. In such an optional embodiment, the gaming machine 42 would cash out the net winnings, defined as the amount by which the winnings exceed the total credit extended, by issuing media of exchange, such as currency, gaming chips, vouchers, or other fungible value media.

In yet another optional embodiment, the player would have to option 34 to store at least a portion of the net winnings in a location accessible to the gaming machine rather than cashing out that portion of the net winnings. As alluded above, the amount could be stored 34 at the server data structure 48, on an identification device, or in another location from which the amount could be retrieved by a gaming machine 42. In such an optional embodiment, the step of calculating 14 the credit available could include summing the difference between the credit limit and credit previously extended, if any, with the previously stored net winnings.

As discussed above, the gaming machines 42 could be located at a single casino property or at two or more casino properties. In an embodiment in which the gaming machines 42 are located at multiple casino properties, one or more servers 44 may be provided. In any event, communication across properties could take many forms, including computer network (local area or wide area), Internet, or the like.

In such an optional embodiment, a gaming machine 42 may optionally extend 18 credit to a player without regard to location, so long as the gaming machine 42 is part of the present system. For example, if the present system includes gaming machines 42 located at Casino A and Casino B, credit could be extended 18 to a player at a gaming machine 42 at Casino B, without regard to where the player applied and received approval for credit or, in an optional embodiment, where the player has already received credit.

While the player's credit account could be managed substantially as discussed above, in an optional embodiment, rules may be adopted to determine when and to whose credit winnings are applied 40. These rules could take many different forms, but in an optional embodiment, the rule would group 36 the credit extended according to the casino property where the gaming machine 42 that extended the credit is located. The groupings would then be ordered 38 and winnings would be applied 40 according to the ordering.

Optionally, the ordering 38 is chronological. That is, the groupings would be ordered 38 according to the chronological order in which credit was extended. Thus, earlier extensions of credit would have winnings applied 40 thereto before later extensions of credit. This rule can be summarized as “first charged, first paid,” meaning that a player who is extended 18 $200.00 in credit at Casino A before being extended 18 $300.00 in credit at Casino B, will have winnings applied 40 against credit at Casino A before winnings are applied 40 against credit at Casino B. Again, reconciliation may take place in real time or after a predetermined delay and could occur continuously or periodically.

While certain embodiments of the present invention have been shown and described it is to be understood that the present invention is subject to many modifications and changes without departing from the spirit and scope of the claims presented herein.

1. A method of managing and controlling credit used by a player gambling at one or more gaming machines, comprising:
determining a credit limit;
determining the credit previously extended to said player, if any, and calculating the credit available as the difference between said credit limit and said credit previously extended;
upon said player being identified at said gaming machine, extending credit to said player in an amount less than or equal to said credit available;
tracking winnings by said player at said gaming machine;
calculating the total credit extended to said player by summing the credit extended at said gaming machine and the credit previously extended, if any; and
disabling said gaming machine from cashing out said winnings by issuing media of exchange so long as said winnings are less than said total credit extended.

2. The method of claim 1 further comprising:
when said winnings are greater than said total credit extended, designating the net winnings as the amount by which said winnings exceed said total credit extended; and
enabling said gaming machine to cash out said net winnings by issuing media of exchange for at least a portion of said net winnings.

3. The method of claim 2 further comprising:
when said winnings are greater than said total credit extended, providing said player the option to store at least a portion of the net winnings in a manner accessible to said one or more gaming machines rather than cashing out.

4. The method of claim 3 wherein the step of determining credit available includes summing net winnings previously stored, if any, with said difference between said credit limit and said credit previously extended, if any.

5. The method of claim 1 further comprising applying said winnings against said total credit extended.

6. The method of claim 1 further comprising storing said credit limit in a manner accessible to said one or more gaming machines.

7. The method of claim 1 further comprising storing said total credit extended in a manner accessible to said one or more gaming machines.

8. A method of managing and controlling credit used by a player gambling at any of a plurality of gaming machines, comprising:
determining a credit limit and storing said credit limit in a manner accessible to said plurality of gaming machines;
determining the credit previously extended to said player, if any, and calculating the credit available as the difference between said credit limit and said credit previously extended;
upon said player being identified at one of said plurality of gaming machines, extending credit to said player in an amount less than or equal to said credit available;
tracking winnings by said player at said plurality of gaming machines;
calculating the total credit extended to said player by summing the credit extended at said plurality of gaming machines and the credit previously extended, if any, and storing said total credit extended in a manner accessible to said plurality of gaming machines; and
disabling said plurality of gaming machines from cashing out said winnings by issuing media of exchange so long as said winnings are less than said total credit extended.

9. The method of claim 8 further comprising:
when said winnings are greater than said total credit extended, designating the net winnings as the amount by which said winnings exceed said total credit extended; and
enabling said gaming machine to cash out said net winnings by issuing media of exchange for at least a portion of said net winnings.

10. The method of claim 9 further comprising:
when said winnings are greater than said total credit extended, providing said player the option to store at least a portion of said net winnings in a manner accessible to said plurality of gaming machines rather than cashing out.

11. The method of claim 10 wherein the step of determining credit available includes summing net winnings previously stored, if any, with said difference between said credit limit and said credit previously extended, if any.

12. The method of claim 8 further comprising applying said winnings against said total credit extended.

13. The method of claim 8 wherein said plurality of gaming machines communicate with a server via computer network.

14. The method of claim 8 wherein said plurality of gaming machines are located at a single casino property.

15. The method of claim 8 wherein said plurality of gaming machines are located at two or more casino properties.

16. The method of claim 15 further comprising:
grouping said credit extended by said plurality of gaming machines according to the casino property where each gaming machine is located;
ordering said groupings of credit extended; and
applying said winnings against said groupings of credit extended according to said ordering.

17. The method of claim 16 wherein said ordering is chronological.

18. A system for managing and controlling credit used by a player for gambling, comprising:
a server including a server data processor and a server data structure, said server data structure storing instructions executable by said server data processor for implementing a method comprising:
determining a credit limit and storing said credit limit at said server data structure; and
determining the credit previously extended to said player, if any, and calculating the credit available as the difference between said credit limit and said credit previously extended;
a plurality of gaming machines, said gaming machines communicating with said server via computer network, each said gaming machine including a machine data processor and a machine data structure, said machine data structure storing instructions executable by said machine data processor for implementing a method comprising:
upon said player being identified at said gaming machine, extending credit to said player in an amount less than or equal to said credit available;
tracking winnings by said player at said gaming machine;
calculating the total credit extended to said player by summing the credit extended at said gaming machine and the credit previously extended, if any; and
disabling said gaming machine from cashing out said winnings by issuing media of exchange so long as said winnings are less than said total credit extended.

19. The system of claim 18 wherein said instructions executable by said machine data processor further comprises:
when said winnings are greater than said total credit extended, designating the net winnings as the amount by which said winnings exceed said total credit extended; and
enabling said gaming machine to cash out said net winnings by issuing media of exchange for at least a portion of said net winnings.

20. The system of claim 19 wherein said instructions executable by said machine data processor further comprise:
when said winnings are greater than said total credit extended, providing said player the option to store at least a portion of said net winnings in a manner accessible to said plurality of gaming machines rather than cashing out.

21. The system of claim 20 wherein in said instructions executable by said server data processor, the step of determining credit available includes summing net winnings previously stored, if any, with said difference between said credit limit and said credit previously extended, if any.

22. The system of claim 18 wherein said instructions executable by said machine data processor further comprise applying said winnings against said total credit extended.

23. The system of claim 18 wherein said plurality of gaming machines are located at a single casino property.

24. The system of claim 18 wherein said plurality of gaming machines are located at two or more casino properties.

25. The system of claim 24 wherein said instructions executable by said server data processor further comprise:
grouping said credit extended by said plurality of gaming machines according to the casino property where each gaming machine is located;
ordering said groupings of credit extended; and
applying said winnings against said groupings of credit extended according to said ordering.

26. The system of claim 25 wherein in said instructions executable by said server data processor, said ordering is chronological.

27. A method of managing and controlling credit used by a player gambling at one or more gaming machines, comprising:
determining a credit limit;
upon said player being identified at said gaming machine, extending credit to said player in an amount less than or equal to said credit limit;
tracking winnings by said player at said gaming machine; and
comparing said credit extended to said winnings.

28. A system for managing and controlling credit used by a player for gambling, comprising:
a server including a server data processor and a server data structure, said server data structure storing instructions executable by said server data processor for implementing a method including determining a credit limit and storing said credit limit at said server data structure;
a plurality of gaming machines, said gaming machines communicating with said server via computer network, each said gaming machine including a machine data processor and a machine data structure, said machine data structure storing instructions executable by said machine data processor for implementing a method comprising:
upon said player being identified at said gaming machine, extending credit to said player in an amount less than or equal to said credit limit;
tracking winnings by said player at said gaming machine; and
comparing said credit extended to said winnings.
